(19) United States
(12) Patent Application Publication
(10) Pub. No.: US 2005/0065873 A1
(43) Pub. Date: Mar. 24, 2005

(54) Retirement plan contribution system and method

(76) Inventors: David W. Hendrickson, Hibbing, MN (US); Gerald J. Lipovetz, Pengilly, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/944,318

(22) Filed: Sep. 17, 2004

Related U.S. Application Data
(60) Provisional application No. 60/504,394, filed on Sep. 19, 2003.

(51) Int. Cl. G06F 17/60

(52) U.S. Cl. 705/38

(57) ABSTRACT

The present invention relates to a method and system of supplying loaned funds to employees for increased participation in employee retirement contribution plans. In particular, the present invention relates to a method and system enabling employees to benefit from retirement plan contributions from employers that match employee contributions, through loaned income supplements to employees under current and future ERISA laws.

### CROSS-REFERENCE TO RELATED APPLICATIONS

This application claims benefit to U.S. Provisional Patent Application Ser. No. 60/504,394, filed Sep. 19, 2003 and entitled “Retirement Plan Contribution System and Method”.

### BACKGROUND

The present invention relates to a system and method of supplying and repaying loaned funds provided to an employee participating in a contribution based retirement plan. In particular, the present invention relates to a method and system for enabling an employee to contribute more funds into his/her retirement plan in order to benefit from employer matching contributions by reimbursing the employee with loaned funds from a third party lending agency.

“Defined Contribution Benefit Plans” have become a dominant employee retirement benefit platform often either supplementing or completely replacing “Defined Benefit Retirement Plans” offered by employers. Generally, these types of plans are regulated under the Employee Retirement Income Security Act (“ERISA”) with, for example, possible restrictions on retirement fund access prior to retirement age or other special circumstances. Examples of Defined Contribution Benefit Plans include 401(k) plans, 403(b) plans, employee stock ownership plans, simplified employee pension plans (SEPs) and profit-sharing plans. Of particular interest, 401(k) plans are a widely known retirement platform today.

One general feature of Defined Contribution Benefit Plans is the possible availability of employer “matching fund” plans, wherein a percentage of employee pre-tax or after-tax contributions are “matched” by an employer. For example, with a 401(k) plan, employee contributions range from 1%-7%, with either a 50% or 100% employer match of the employee contribution. Generally speaking, such matching plans offer employees additional “free” contribution funds from their employer if the employee is able to contribute to the plan. Further, the employee will only obtain the most benefit of these “free funds” by contributing the highest percentage of his/her salary that is eligible under both a particular employer's “matching fund” plan and current and/or future ERISA laws or other regulatory laws.

A large opportunity exits within the framework of retirement savings plans, such as 401(k) Retirement Savings Plans, to allow for change and improvement in an employee's ability to save for retirement. Some background information supporting this opportunity includes:
Annual U.S. 401(k) Investment by employees in 2002 is estimated to be greater than $1,800,000,000,000.00 (1.8 trillion dollars) per year.
Approximately 340,000 companies offered 401(k) plans in 2002.
Approximately 42,000,000 employees were enrolled in 401(k) plans in 2002.
It is estimated that 30% to 35% of U.S. employees in salary ranges from as low as $15,000.00-$25,000.00 per year to greater than $100,000.00 per year do not take full advantage of their employer's 401(k) Matching Plans where employers match employee's salary pre-tax or after-tax fund contributions (1% to 7%) at a 50% or 100% rate.
Other contribution-based retirement plans having employer-matching opportunities (e.g., Simple IRA Plans) are also quite popular, but generally underutilized by employees.

Sadly, as evidenced by the above, many employees are unable to contribute the funds necessary to realize the optimal amount of employer-contributed matching funds. In times of economic hardship, employees simply cannot afford to make the contribution from their salary each month, essentially forfeiting “free funds” otherwise available to them from their employer for their future retirement.

As a result, a need exists for a system and method of extending financial assistance to employees with access to contribution matching plans by employers. This method should allow employees to secure the maximum matching funds available to them without the increased financial burden associated with providing a maximum contribution.

### BRIEF DESCRIPTION OF THE DRAWINGS

FIG. 1 is a block diagram of one embodiment of the present invention;

FIG. 2 is a transactional flowchart of an exemplary embodiment of the present invention including a 401(k) retirement plan; and

FIG. 3 is a flowchart of example calculations associated with a hypothetical employee utilizing the methodology of FIG. 2.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

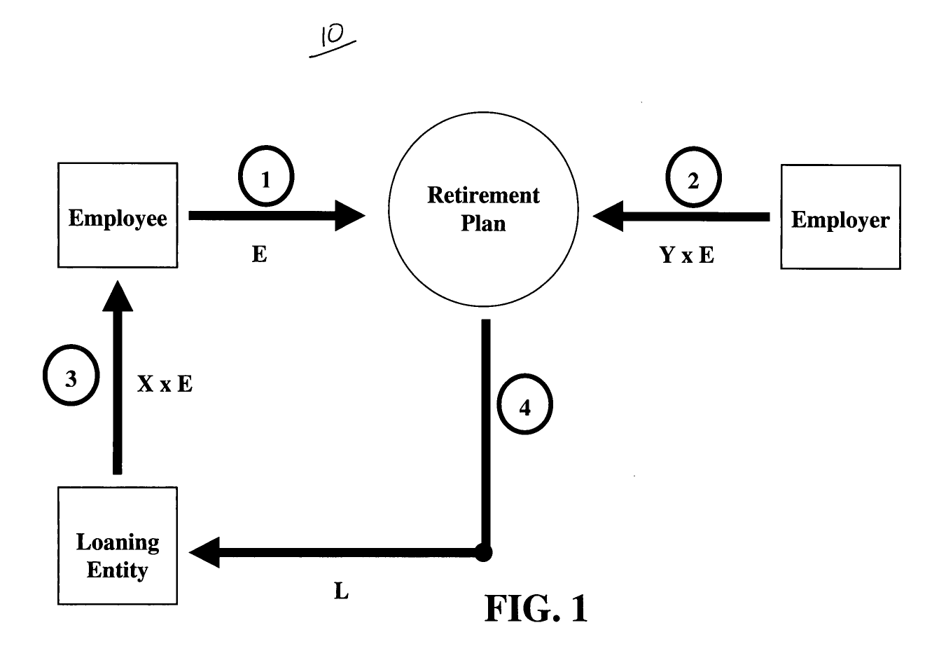

FIG. 1 illustrates one embodiment of a retirement plan contribution system and method of the present invention. With the embodiment of FIG. 1, the present invention may be generally described as providing a system 10 for performing transactions between an employee (“Employee”) employed by an employer (“Employer”) that otherwise offers participation in qualified, contribution-based retirement plan (“Retirement Plan”) and an appropriate loaning entity (“Loaning Entity”) such as a bank. With this in mind, the system 10 is adapted to facilitate four transactions: An Employee contribution transaction 1 into the Retirement Plan; an Employer contribution-matching transaction 2 into the Retirement Plan; an Employee income supplementing transaction 3 from the Loaning Entity to the Employee; and Loaning Entity reimbursement transaction 4 from the Retirement Plan. As will be described in greater detail below, these four transactions allow the Employee to consistently receive maximum matching contributions by the Employer into the Employee's Retirement Plan by reimbursing the Employee with loaned funds from the Loaning Entity.

The term “retirement plan” may be generally described as including “Defined Contribution Benefit Plans” with the Employee or his/her assignees, etc., as beneficiaries of the plan. These plans include, but are not limited to, 401(k) plans, 403(b) plans, employee stock ownership plans, Simple Individual Retirement Accounts (“Simple IRAs”), simplified employee pension plans (SEPs) and profit sharing plans, among others. The term “transaction” includes a variety of fund transfers possible to parties involved with Defined Contribution Benefit Plans. Additionally, the components/transactions of the present invention can be implemented in hardware via a microprocessor, programmable logic, or state machine, in firmware, or in software with a given device. In one aspect, at least a portion of the software programming is web-based and written in HTML and JAVA programming languages, including links to user interfaces for data collection, such as a Windows based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term “computer-readable medium” as used herein is defined to include any kind of memory, volatile or non-volatile, such as floppy disks, hard disks, CD-ROMs, flash memory, read-only memory (ROM), and random excess memory (RAM).

With reference to FIG. 1, the Employee contribution transaction 1 includes a deposit of Employee funds E into the Retirement Plan of a Defined Contribution Benefit Plan. In a preferred embodiment the Employee funds E represent after-tax dollars deducted from the periodic paycheck paid to the Employee from the Employer. In another embodiment, the Employee funds E are deducted from the paycheck of the Employee prior to taxation. The periodicity of the paycheck and corresponding deduction may vary, but one embodiment of the present invention corresponds to a monthly pay period, which in turn, corresponds to a monthly paycheck deduction transferred into the Retirement Plan. The size of the deduction may vary according to the particular Retirement Plan and applicable regulatory law. In one preferred embodiment, the Employee contribution transaction 1 would be recognized by one of ordinary skill in the art to include a pre-tax employee deposit into a 401(k) retirement savings plan, with a remainder of the paycheck being dispersed to the Employee or elsewhere.

The Employer contribution-matching transaction 2 into the Retirement Plan includes the Employer matching the Employee contributed funds E with additional funds representing a matching percentage Y of the Employee contributed funds E into the Retirement Plan. The matching percentage Y is a function of the particular Retirement Plan and the Employer's implementation thereof. For example, in one embodiment, the matching percentage Y is 100%. With this one example, twice the amount of the Employee contributed funds E will be contributed to the Retirement Plan (2E=Y×E+E where Y=100%) upon each Employee contribution transaction 1. It is to be noted that a variety of matching percentages Y are included within the scope of the present invention, for example 50%. Further, in one preferred embodiment, the Employer matching contribution transaction 2 can be a matching percentage Y associated with a pre-tax Employee deposited into the Retirement Plan.

The Employee income supplementing transaction 3 from the Loaning Entity to the Employee includes the Loaning Entity transferring supplemental funds equal to a supplement percentage X of the Employee contributed funds E to the Employee. In a preferred embodiment, the supplement percentage X is 80% of the Employee contributed funds E, with the Employee income supplementing transaction 3 occurring at the same frequency as the Employee contribution transaction 1. In a more preferred embodiment, the supplemental funds are transferred into a bank account of the Employee immediately after the Employee contribution transaction 1, such that supplemental funds are available to the Employee immediately following a paycheck deduction.

With the embodiment of FIG. 1, the Loaning Entity reimbursement transaction 4 from the Retirement Plan can be described to include a dispersal of reimbursement funds L from the Retirement Plan to the Loaning Entity. In one preferred embodiment, the reimbursement funds L are of an amount equal to the Employee contribution funds E. Additionally, the Loaning Entity reimbursement transaction 4 can have the same periodicity as the Employee contribution transaction 1 or the Employee income supplementing transaction 3. Alternatively, the Loaning Entity reimbursement transaction 4 can occur on a differing schedule, such as a yearly basis. In one embodiment in which the Loaning Entity reimbursement transaction 4 occurs annually, the Employee contribution transaction 1 occurs monthly, and the reimbursement funds L are equal to twelve times the Employee contribution funds E (12×E). In another embodiment, the transaction 4 includes the use of an automated (e-Based) Loan Type Paperless Transaction Package made available to all U.S. employees where a large financial institution loans employees funds to allow them to secure the additional 401(k) match offered them by the employers in return for a interest commission through repayment of the loan as described above.

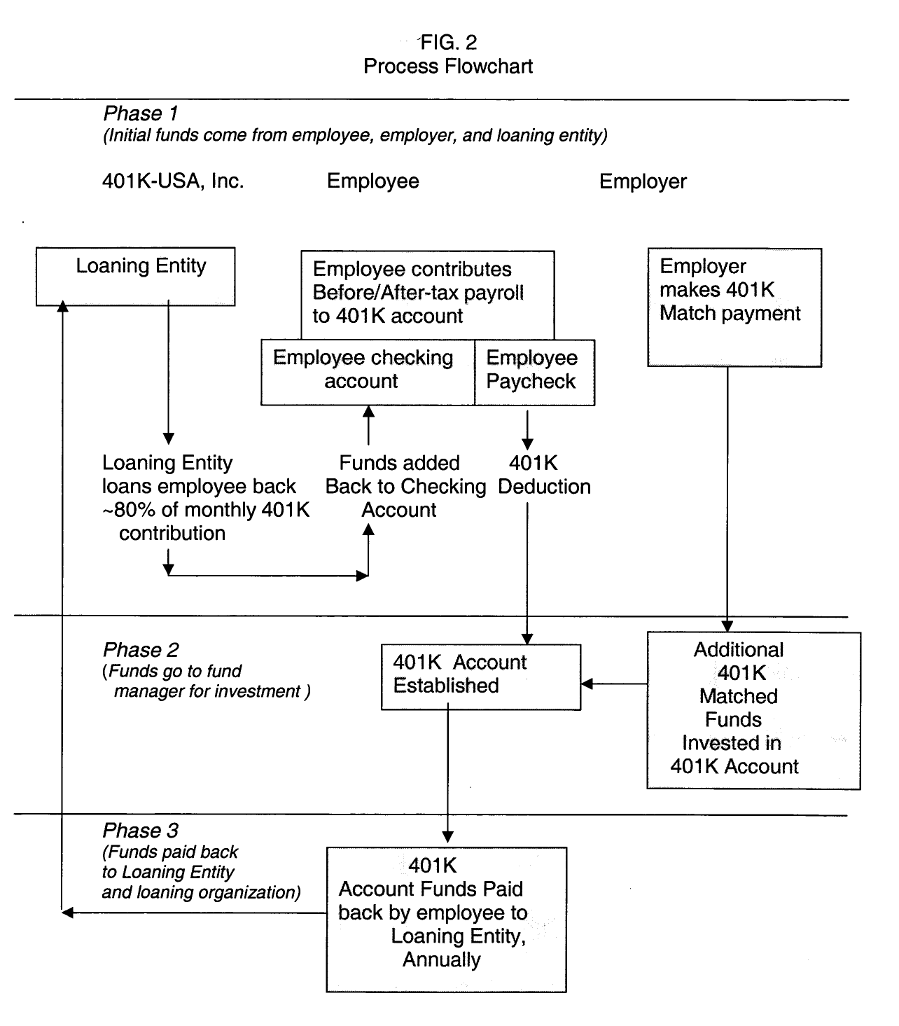

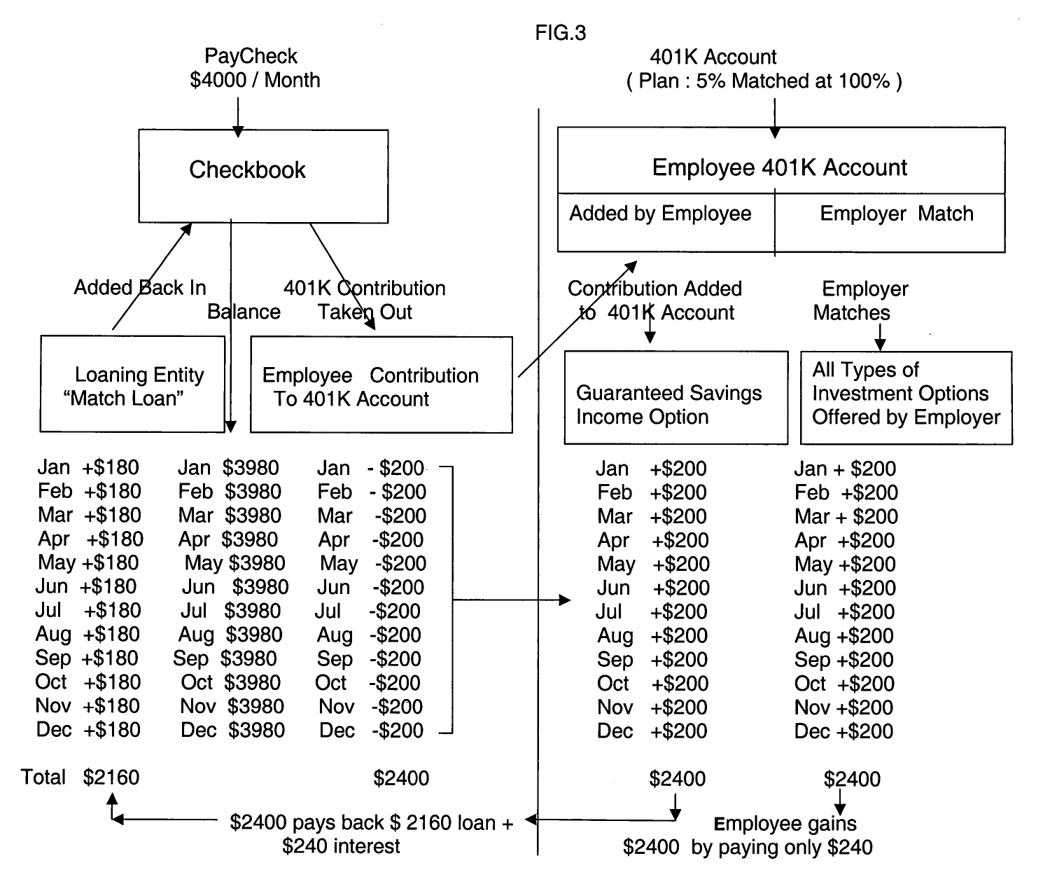

Exemplary Embodiments of FIGS. 2 and 3 Including a 401(k) Retirement Plan Contribution Method and System

The method of the present invention can be described with reference to the exemplary flowchart of FIG. 2 that otherwise relates to a 401(k) Retirement Plan in conjunction with the flowchart of FIG. 3 that provides specific dollar amounts for a hypothetical employee using the system and method of FIGS. 1 and 2 as part of a 401(k) Retirement Plan. In general terms, and as illustrated in FIG. 2, at Step or Phase 1, the Employee contributes to his/her 401(k) account via a payroll deduction (i.e., Employee contribution transaction); the Employer makes a matching payment to the Employee's 401(k) account (i.e., Employer contribution-matching transaction); and the Loaning Entity automatically transfers (or loans) a percentage of the Employee contribution to the Employee (i.e., Employee income supplementing transaction). At Step or Phase 2, the 401(k) account is managed in accordance with pre-defined parameters. At Step or Phase 3, the Loaning Entity automatically receives a payment or reimbursement from the 401(k) account in payment of amounts loaned to the Employee (i.e., Loaning Entity reimbursement transaction).

With the example of FIG. 3, $200.00 is deducted from the employee's paycheck each month as the employee contribution transaction. In one embodiment, the employee contribution funds are invested into a Guaranteed Savings Income Option and accumulated for twelve consecutive months. In this manner, there is reduced risk to this money as it is invested in guaranteed funds (Money Market funds, for example). Further, the employer's match can be added monthly and invested as designated by the employee into various types of investment options. In the exemplary system and method, those monthly contributions also accumulate for the twelve-month period.

With continued reference to the examples of FIG. 3, the loaning entity is a “Match Loan” financial backer along with a large-scale financial institution. In this exemplary embodiment, the loaning entity can make monthly advances to the employee's checking account equal to 90% of the $200 deducted, which amounts to $180. Preferably, this amount provides sufficient coverage such that the employee sees little difference ($20 in this example) in his/her checkbook balance during the process of removing and replacing funds to enable the funding of his/her 401(k) account. Employees thus have sufficient funds to meet monthly expenses while securing their employer's 401(k) matching funds. With the hypothetical of FIG. 3, the employee has accumulated $2400 of matched money by year's end.

With reference to FIGS. 2 and 3, the loan transaction (or employee income supplementing transaction) follows a typical “80/20” rule. Thus, a typical 20% interest commission is charged to employees to gain an 80% loan of funds used to secure the matching funds from their employer. Alternatively, other percentages can be utilized. In one embodiment, a loan transaction may be described with reference to an employee having a 1-7% pre-tax/post-tax 401(k) matching plan where the employer matches 100% of the employee contribution. In a related embodiment, the employee is paid on a monthly basis and the employee chooses a pre-tax 401(k) plan. The loan transaction can include the employee signing up for the 401(k) matching program at a 7% match with the 7% (pre-tax) funds withdrawn from the monthly paycheck of the employee and put into a 401(k) account with the 100% match made by the employer. Additionally, a preferred embodiment includes the loaning entity backing the employee 80% of the 7% withdrawn from his paycheck, which is deposited back into his payroll savings account electronically the day after the funds are withdrawn from the employee's check. In doing this electronic transaction, the employee hardly sees a difference in the monthly paycheck of the employee (reduced by 20% of 7% rather than the full 7%), yet gains the full “free” money, or contribution matching funds, paid by the employer in making the match.

With reference to FIGS. 2 and 3, a preferred embodiment of the Loan Payback transaction (or the Loaning Entity reimbursement transaction) includes the employee signing a contract with the Loaning Entity to pack back funds loaned them at year-end. In one example, the employee pays a 20% fee to get a 100% match on 401(k) Funds. Thus, employees can build up retirement funds to full advantage without committing their own funds on a paycheck-to-paycheck basis. As a normative proposition, many people need all their paycheck dollars to make it month-to-month. This is a possible explanation as to why people offered 401(k) programs do not take advantage of them.

In a preferred embodiment, the loan offering can be a one-year renewable “note” having monthly loan payouts to enrolled employees who will be required to repay the 12-month loan or note early the following year. Employees can have a number of options available to them concerning loan repayment. In one embodiment, the repayment is a one-time withdrawal option available in most post-tax 401(k) plans known to those of ordinary skill in the art. In this manner, employees can use this one time withdrawal of their 401(k) contributions made over the year to repay the loan (with commission) in one lump sum. The employee simply repays his total 401(k) contribution back to the loaning institution and retains the employer-matched funds.

With the above parameters in mind, the transaction dollar amounts for another hypothetical employee, retirement plan, and employer operating in accordance with the system and method of the present invention, provide the following results:
Assume the Employee earns $48,000.00 per year.
Assuming a 100% employer match at 7% means a $3,360.00 employee contribution gaining an additional $3,360.00 match (total=employee contribution+employer match=$6,720.00 per year).
Loaning entity loans back the employee $2,688 per year on a paycheck-by-paycheck basis ($3,360/yr×0.80=$2,688) or $224/month. The remaining 20% or $56/month is the interest commission the employee pays to gain the “free” matched money and have the financial institution take care of all the electronic transactions and interest payment on the loan to them. (Note: the 80/20 calculation could be changed to other ratios to be determined at whatever the market can bear, for example 85/15).
The total match by the employer is $3,360.00 per year.
In summary, the employee pays $672.00 per year in this example to have a 401(k) account build to $3,360.00 per year each year, which then can earn more money as it is invested or placed in a savings account.

As is demonstrated by the description above and accompanying figures, the present invention fulfills the need for a system and method of extending financial assistance to employees with access to contribution matching plans by employers. This method allows employees to secure the maximum matching funds available to them without the increased financial burden associated with providing a maximum contribution.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the chemical, mechanical, electromechanical, electrical, and computer arts will readily appreciate that the present invention may be implemented in a wide variety of embodiments. This application is intended to cover any adaptations or variations of the preferred embodiments discussed herein. Therefore it is manifestly intended that this invention be limited only by the claims and the equivalents thereof.

1. A method of supplying and repaying funds provided to an employee participating in a contribution based retirement plan, the method comprising:
performing an employee contribution transaction into an employee retirement plan;
performing an employer contribution-matching transaction into the retirement plan, wherein at least a portion of an amount deposited from the contribution-matching transaction is determined by an amount deposited in the employee contribution transaction;
performing an employee income supplementing transaction from a loaning entity to the employee; and
performing a loaning entity reimbursement transaction from the retirement plan to the loaning entity.

2. The method of claim 1, wherein at least a portion of the amount deposited in the employee contribution transaction is a pre-tax employee paycheck deduction.

3. The method of claim 1, wherein the employee income supplementing transaction is configured to occur on a periodic basis and the loaning entity reimbursement transaction is configured to occur on a periodic basis, and further wherein the loaning entity reimbursement transaction and the employee contribution transaction are configured to have a substantially similar periodicity.

4. The method of claim 1, wherein the employee income supplementing transaction occurs on a periodic basis, such that performing the employee income supplementing transaction includes performing a plurality of income supplementing transactions and the loaning entity reimbursement transaction occurs on a periodic basis, such performing the loaning entity reimbursement transactions includes performing a plurality of loaning entity reimbursement transactions, the plurality of employee income supplementing transactions having a higher periodicity than the plurality of loaning entity reimbursement transactions.

5. The method of claim 1, wherein the loaning entity reimbursement transaction is configured to occur on a monthly basis.

6. The method of claim 1, wherein the loaning entity reimbursement transaction is configured to occur on an annual basis.

7. The method of claim 1, wherein an amount of the employee income supplementing transaction is equal to the amount of the employee contribution transaction.

8. The method of claim 1, wherein the employee income supplementing transaction occurs on a periodic basis, such that performing the employee income supplementing transaction includes performing a plurality of income supplementing transactions and the employee contribution transaction occurs on a periodic basis, such that performing the employee contribution transaction includes performing a plurality of income supplementing transactions, and further wherein a total amount of the plurality of employee income supplementing transactions is equal to a total amount of the plurality employee contribution transactions over a period of time.

9. The method of claim 1, wherein an amount of the loaning entity reimbursement transaction is greater than an amount of the employee income supplementing transaction.

10. The method of claim 1, wherein the employee income supplementing transaction occurs on a periodic basis, such that performing the employee income supplementing transaction includes performing a plurality of income supplementing transactions and the loaning entity reimbursement transaction occurs on a periodic basis, such that performing the loaning entity reimbursement transaction includes performing a plurality of loaning entity reimbursement transactions, and further wherein a total amount of the plurality of employee income supplementing transactions is less than a total amount of the plurality loaning entity reimbursement transactions over a period of time.

11. The method of claim 10, wherein the period of time is one year.

12. The method of claim 10, wherein the amount of the employee income supplementing transaction is between 70% and 95% of the loaning entity reimbursement transaction.

13. The method of claim 1, wherein the employee retirement plan includes a Guaranteed Savings Income account.

14. The method of claim 1, wherein the employee retirement plan is substantially similar to a pre-tax 401(k) plan.

15. The method of claim 1, wherein the employee retirement plan is substantially similar to a post-tax 401(k) plan.

16. A method of supplementing income of an employee participating in a contribution based retirement plan comprising:
advancing funds into a supplemental income account of an employee in order to supplement an income of an employee participating in a contribution-matching retirement plan, wherein the amount of funds advanced into the supplemental income account is determined by a payroll contribution of an employee into a contribution-matching retirement plan; and
receiving repayment funds for the funds advanced into the supplemental income account from the contribution-matching retirement plan of the employee, wherein the repayment funds are greater than the advanced funds.

17. The method of claim 16, wherein the employee can choose to contribute pre-tax or post-tax payroll funds to the contribution-matching retirement plan.

18. The method of claim 16, wherein a total amount of funds advanced to the employee is between 70% to 90% of a total amount of the employee payroll contribution for a given time period.

19. A method of participating in a contribution based retirement plan comprising:
creating a specialized 401K Match Loan Account for an employee, such that loaned funds are advanced into an employee banking account on a periodic basis after finds are contributed by the employee from a payroll of the employee into an employee 401K account;
wherein the amount of the 401K Match Loan advanced to the employee is 70% to 90% of the employee 401K contribution;
wherein the employee 401K contributions are deposited in a Guaranteed Income Savings (GIC) type account;
wherein employees chose to apply pretax or post tax payroll funds to create their 401K account;
wherein the difference between 401K monthly contributions made by employees into their 401K (GIC) account and the amount advanced into their checking accounts represents 401K Match Loan interest and other fees paid to secure the 401K Match Loan.
